(19) United States
(12) Patent Application Publication
(10) Pub. No.: US 2008/0246692 A1
(43) Pub. Date: Oct. 9, 2008

(54) FOLDABLE MULTI-DISPLAY APPARATUS

(75) Inventors: Jae-Woo JEONG, Yongin-si (KR); In-seo KEE, Yongin-si (KR); Joong-kyung PARK, Yongin-si (KR); Young-gu LEE, Yongin-si (KR); Hong-shik SHIM, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/954,299

(22) Filed: Dec. 12, 2007

(30) Foreign Application Priority Data
Apr. 5, 2007 (KR) 10-2007-0033768

(51) Int. Cl. G09G 5/00

(52) U.S. Cl. 345/1.3

(57) ABSTRACT

Provided is a foldable multi-display apparatus that forms a foldable type large screen by connecting housings in which unit display panels are supported. The foldable multi-display apparatus includes a sliding member that moves the unit display panel supported by the housing towards the adjacent unit display panel when an unfolding operation is completed. The foldable multi-display apparatus can prevent scratching between the unit display panels during unfolding operations, thereby having increased reliability and lifespan.

### CROSS-REFERENCE TO RELATED PATENT APPLICATION

This application claims the benefit of Korean Patent Application No. 10-2007-0033768, filed on Apr. 5, 2007, in the Korean Intellectual Property Office, the disclosure of which is incorporated herein in its entirety by reference.

### BACKGROUND OF THE INVENTION

1. Field of the Invention

The present invention relates to a foldable multi-display apparatus that forms a foldable type large screen by connecting multiple display panels, and more particularly, to a foldable multi-display apparatus that has reduced wearing between panels during folding and unfolding operations.

2. Description of the Related Art

Conventionally, multi-display apparatuses form a large screen by connecting a plurality of display panels. In the past, a large screen was realized by connecting a plurality of Brown Tubes into a large TV. However, recently, due to the increasing demands for a large screen in small mobile apparatuses such as mobile phones or personal digital assistants (PDAs), apparatuses that form a large screen by connecting flat panel displays such as liquid crystal displays (LCDs), field emission displays (FEDs), plasma display panels (PDPs), and organic light-emitting diodes (LEDs) are being produced.

Conventionally, as depicted in FIG. 1, two flat display panels 10 are connected in a folding type apparatus, that is, the flat display panels 10 are connected to be able to fold and unfold with respect to a hinge axis H supported by a housing 20. Thus, when carrying the folding type apparatus, the two flat display panels 10 are folded, and when it is necessary to use the folding type apparatus, the two flat display panels 10 are unfolded to form one screen as depicted in FIG. 1.

However, when the two folded display panels 10 are unfolded, a seam between the two display panel 10 wears due to collision of two end parts of the display panels 10. That is, the two display panels 10 must contact each other as tight as possible when the two display panels 10 are unfolded to display a smooth image, and thus, the two end parts of the display panels 10 come into contact before they are completely unfolded. As a result, the two display panels 10 wear away by scratching each other during folding and unfolding operations.

Conventionally, the display panels 10 have a structure as depicted in FIG. 2. A display device 12 is installed on a substrate 11, and a cover 13 having an encapsulation member covers the display device 12. Since the substrate 11 and the cover 13 are formed of a material having high hardness, severe wear and damage to the display panels 10 can occur when folding and unfolding operations are repeated.

### SUMMARY OF THE INVENTION

To solve the above and/or other problems, the present invention provides a foldable multi-display apparatus that can prevent a contact between unit display panels during unfolding operations.

According to an aspect of the present invention, there is provided a foldable multi-display apparatus that forms a foldable type large screen by connecting a pair of housings in which unit display panels are supported, wherein one of the pair of the housings comprises a sliding member that moves the display panel supported by the housing towards the adjacent unit display panel when an unfolding operation is completed so that the two unit display panels contact each other when the unfolding operation of the two housings is completed.

The sliding member may comprise: a cam member installed in a hinge axis of the one of the pair of housings and having a cam surface on an external circumference thereof; a contact protrusion formed on the unit display panel to contact the cam surface; and an elastic member that supplies an elastic force to the contact protrusion to tightly contact the cam surface, wherein the cam surface is formed to have a profile along which the unit display panel having the contact protrusion moves towards the adjacent unit display panel when the two housings are completely unfolded.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a conventional a foldable multi-display apparatus;

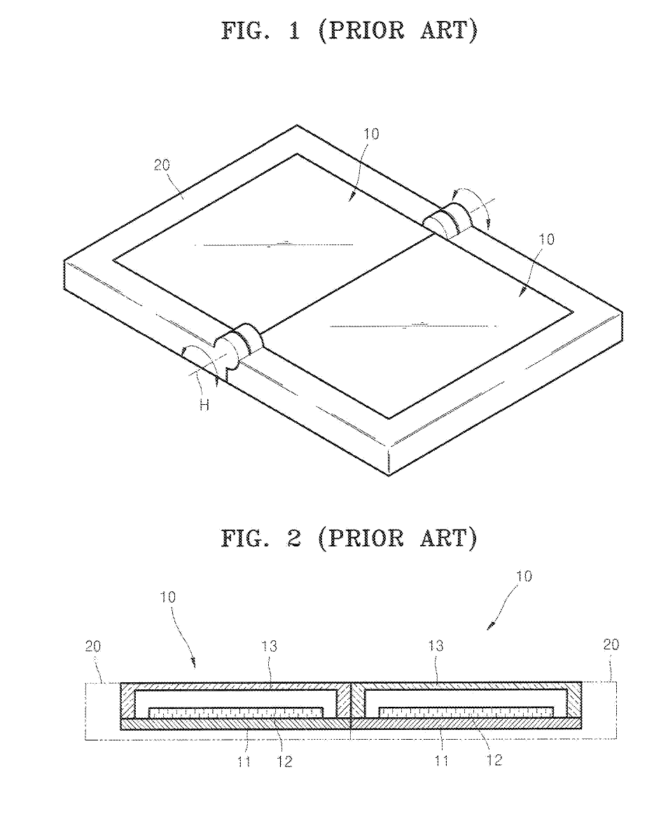

FIG. 2 is a cross-sectional view of the structure of a unit display panel employed in the foldable multi-display apparatus of FIG. 1:

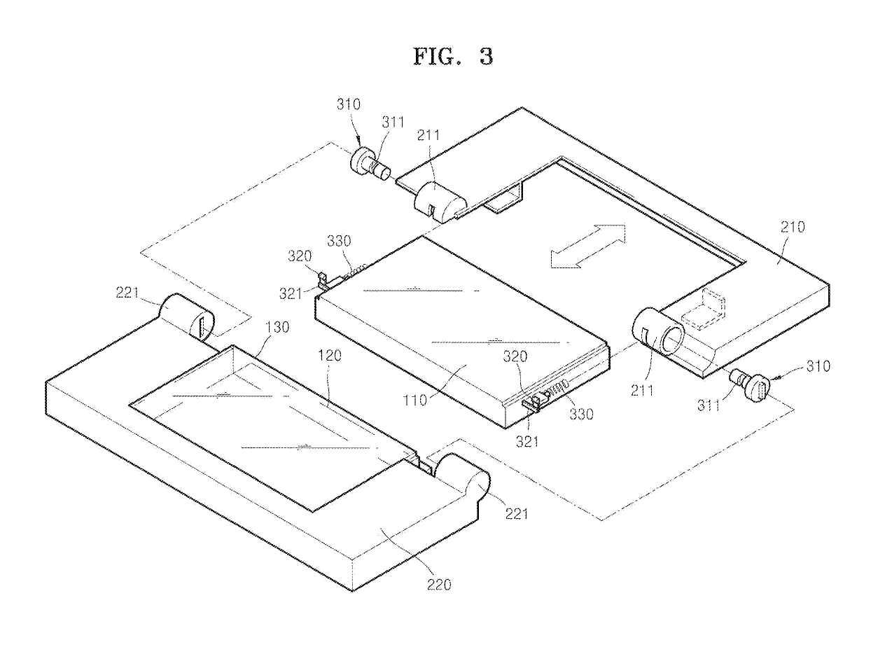

FIG. 3 is an exploded perspective view of a foldable multi-display apparatus according to an embodiment of the present invention;

FIGS. 4A through 4C are cross-sectional views sequentially showing an unfolding operation of the foldable multi-display apparatus of FIG. 3, according to an embodiment of the present invention;

FIGS. 5A and 5B are perspective views respectively showing the state of a cam surface and a contact protrusion at points of FIG. 4B and FIG. 4C; and

FIGS. 6A and 6B are perspective views showing examples of another folding directions of a housing of the foldable multi-display apparatus.

### DETAILED DESCRIPTION OF THE INVENTION

The present invention will now be described more fully with reference to the accompanying drawings in which exemplary embodiments of the invention are shown.

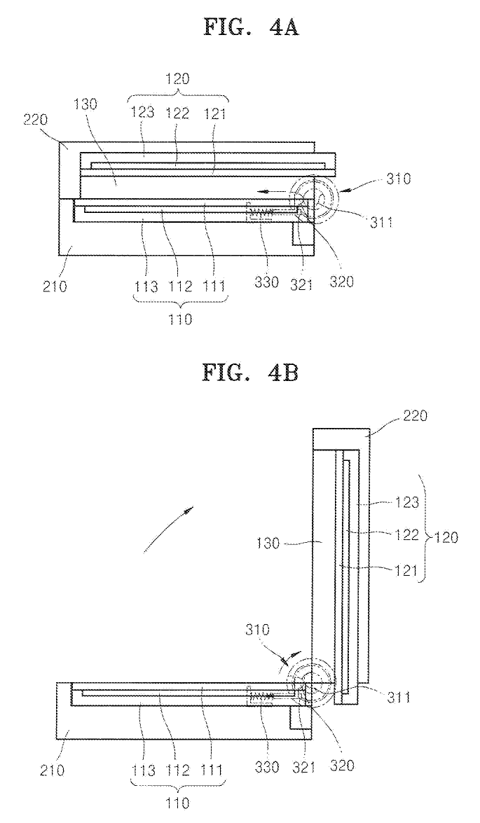

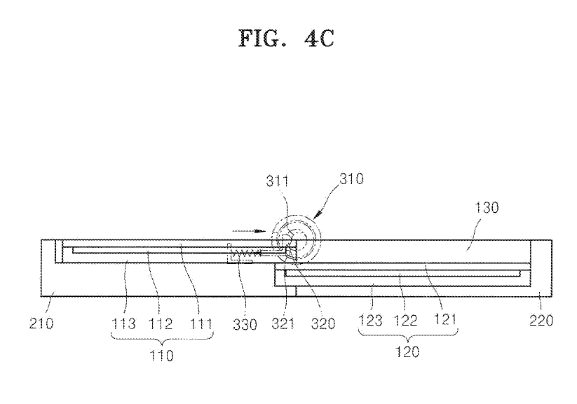

FIG. 3 is an exploded perspective view of a foldable multi-display apparatus according to an embodiment of the present invention. FIGS. 4A through 4C are cross-sectional views sequentially showing an unfolding operation of the foldable multi-display apparatus of FIG. 3. The foldable multi-display apparatus can be formed by connecting a plurality of unit display panels in various ways. However, in the present embodiment, for convenience of explanation, the connection of two unit display panels 110 and 120 will be described. Also, a simplified form of display devices 112 and 122 that display an image is depicted.

Referring to FIGS. 4A through 4C, the unit display panels 110 and 120 respectively have main structures in which the display devices 112 and 122 are stacked on substrates 111 and 121, and encapsulation members 113 and 123 cover the display devices 112 and 122. The encapsulation members 113 and 123 can be cover glasses or thin film sealing members in which organic material layers and inorganic material layers are alternately stacked to cover the display devices 112 and 122.

Referring to FIG. 3, the two unit display panels 110 and 120 having the above structure form a multi-screen by being connected in a foldable type that can be folded and unfolded with respect to hinge axes 211 and 221. When the foldable multi-display apparatus is unfolded, the two unit display panels 110 and 120 have a step difference as depicted in FIG. 4C. This structure is to make the image look connected when the image is seen from above the seam of the two unit display panels 110 and 120 by overlapping boundaries of the two display devices 112 and 122. Reference numeral 130 indicates a transparent plastic plate to match the upper surfaces of the two unit display panels 110 and 120 with each other.

Of the two unit display panels 110 and 120, the unit display panel 120, to which the transparent plastic plate 130 is attached, is fixed on a housing 220. However, the unit display panel 110 located on the fixed unit display panel 120 is structured to be able to move by a sliding member, which will be described later, while being supported by a corresponding housing 210. That is, when the two housings 210 and 220 of the two unit display panels 110 and 120 are folded, the unit display panel 110 is moved in a direction away from the fixed unit display panel 120 and when the two housings 210 and 220 are unfolded, the unit display panel 110 moves towards the fixed unit display panel 120 to tightly contact the fixed unit display panel 120.

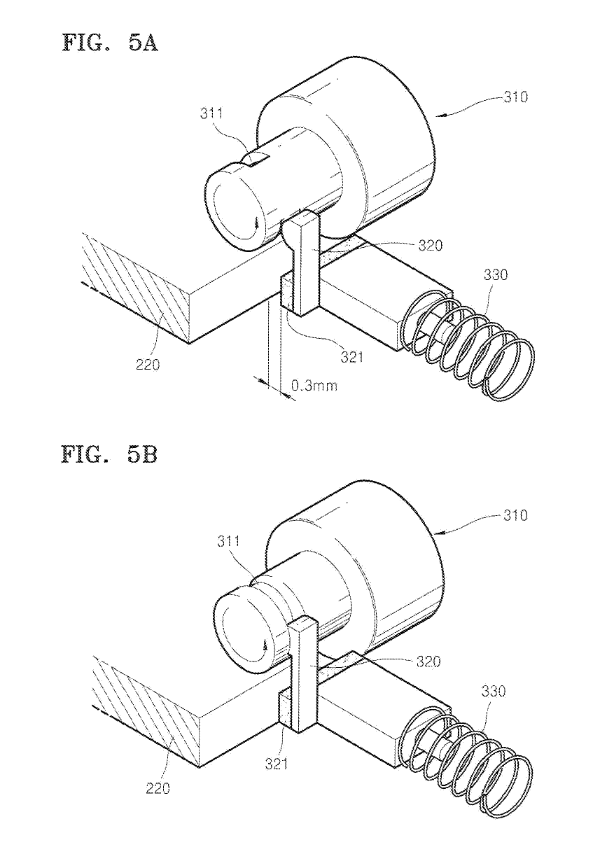

As depicted in FIG. 3, the sliding member includes a cam member 310 mounted on the hinge axes 211 and 221 of the housings 210 and 220, a contact protrusion 320 formed in one unit with the moving unit display panel 110, and a spring 330 that applies an elastic force to the contact protrusion 320 so that the contact protrusion 320 can tightly contact a cam surface 311 of the cam member 310. In a coupled state, the contact protrusion 320 of the moving unit display panel 110 is continuously acted upon by an elastic force of the spring 330 to tightly contact the cam surface 311, and the profile of the cam surface 311 is formed so that the moving unit display panel 110 can move towards the fixed unit display panel 120 to tightly contact the fixed unit display panel 120 when the two housings 210 and 220 are completely unfolded at 180°. The cam surface 311 is a groove formed in an external circumference of a cylinder of the cam member 310, and a depth from an initial position where the contact protrusion 320 contacts the groove in a folded state to a final position, i.e., the deepest position where the contact protrusion 320 contacts the groove is approximately 0.5 mm. In other words, the traveling distance of the contact protrusion 320 is 0.5 mm. A damper 321 for impact mitigation is formed of rubber on a lower end part of the contact protrusion 320. The damper 321 functions as a buffer to reduce the impact between the lower end part of the contact protrusion 320 and the housing 220 when the two unit display panels 110 and 120 tightly contact each other by unfolding the foldable multi-display apparatus. As depicted in FIGS. 5A and 5B, a region for the contact between the damper 321 and the housing 220 is provided on the housing 220 so that the damper 321 can contact the housing 220 when the unit display panels 110 and 120 are unfolded. In a folding state, a gap between the damper 321 and the housing 220 is approximately 0.3 mm. That is, when the contact protrusion 320 enters the groove of the cam surface 311 as an unfolding operation is progressing, the damper 321 firstly contacts the housing 220 and functions as a buffer, and while the contact protrusion 320 is moving further by a distance of approximately 0.2 mm, the damper 321 is elastically compressed.

In this configuration, in a folding state when the two housings 210 and 220 are folded, as depicted in FIG. 4A, the moving unit display panel 110 moves away from the fixed unit display panel 120 due to the mutual action of the cam surface 311 and the contact protrusion 320. That is, until the two housings 210 and 220 are completely unfolded, the sliding member separates the two unit display panels 110 and 120 not to contact each other.

Afterwards, as depicted in FIG. 4B, an unfolding angle exceeds 900 as the unfolding operation is progressing, and the contact protrusion 320 starts to move along the cam surface 311 towards the fixed unit display panel 120. The contact protrusion 320 is formed in one unit with the fixed unit display panel 120. Thus, when the contact protrusion 320 moves, the unit display panel 110 also moves. However, at this point, the two unit display panels 110 and 120 do not contact each other. FIG. 5A is a perspective view showing the above state. The contact protrusion 320 starts to move by entering into the groove of the cam surface 311, and the damper 321 and the housing 220 are still not in contact with each other.

Afterwards, as depicted in FIG. 4C, the two housings 210 and 220 are completely unfolded at the unfolding angle of 1800, the contact protrusion 320 enters the deepest location of the cam surface 311, and the two unit display panels 110 and 120 tightly contact each other as depicted in FIG. 5B. At this point, the damper 321 is compressed to tightly contact the housing 220, and the contact protrusion 320 travels the maximum distance. In this state, boundaries of the two display devices 112 and 122 of the two unit display panels 110 and 120 are arranged to display a smoothly connected image.

The folding operation proceeds in an opposite manner to the unfolding operation.

Until the two housings 210 and 220 are not completely unfolded, the two unit display panels 110 and 120 do not contact each other. Therefore, scratching damage of the two unit display panels 110 and 120 cannot occur during the unfolding operation.

The two unit display panels 110 and 120 are arranged to have a step difference when the two unit display panels 110 and 120 are completely unfolded. This arrangement has the advantage of mitigating the impact when the two unit display panels 110 and 120 contact each other besides the continuity improvement of an image displayed over the two unit display panels 110 and 120. Also, a transparent plastic plate 130 is installed on the fixed unit display panel 120 to match the upper surfaces of the unit display panel 110 and the unit display panel 120 with each other. At this point, when the two unit display panels 110 and 120 tightly contact each other, the substrate 111 of the unit display panel 110 and the end part of the cover 113 contact the transparent plastic plate 130 formed on the fixed unit display panel 120. Conventionally, the substrate 111 and the cover 113 are formed of hard glass materials, however, the transparent plastic plate 130 is formed of a flexible plastic material. Thus, the transparent plastic plate 130 can reduce the impact caused during the unfolding operation, thereby removing the cause of wearing of the unit display panels 110 and 120.

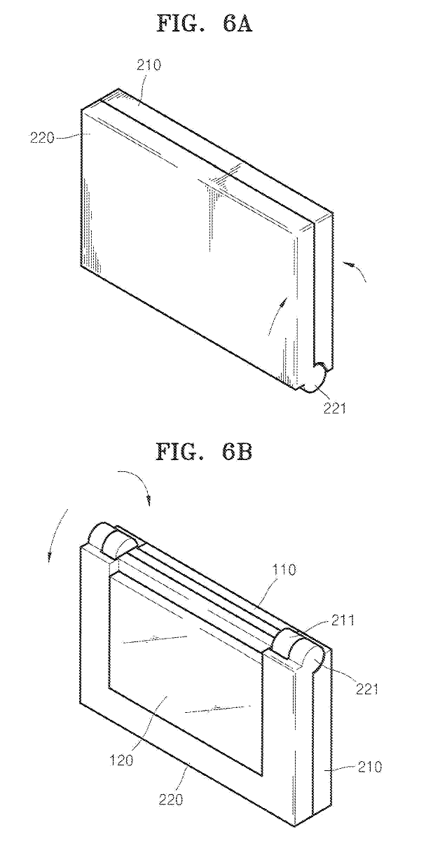

In the present embodiment, as depicted in FIG. 6A, the two unit display panels 110 and 120 are not seen when the two housings 210 and 220 are folded since the two unit display panels 110 and 120 are located inside the two housings 210 and 220. However, as depicted in FIG. 6B, the two unit display panels 110 and 120 can be configured to be exposed in a folded state by changing the location of the hinge axes 211 and 221.

The display devices 112 and 122 can be flat panel display devices such as liquid crystal displays (LCDs), field emission displays (FEDs), plasma display panels (PDPs), or organic light-emitting diodes (OLEDs).

As described above, a foldable multi-display apparatus according to the present invention can prevent scratching between unit display panels during unfolding operations, thereby having increased reliability and lifespan.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A foldable multi-display apparatus that forms a foldable type large screen by connecting a pair of housings in which unit display panels are supported,
wherein one of the pair of the housings comprises a sliding member that moves the display panel supported by the housing towards the adjacent unit display panel when an unfolding operation is completed so that the two unit display panels contact each other when the unfolding operation of the two housings is completed.

2. The foldable multi-display apparatus of claim 1, wherein the sliding member comprises:
a cam member installed in a hinge axis of the one of the pair of housings and having a cam surface on an external circumference thereof;
a contact protrusion formed on the unit display panel to contact the cam surface; and
an elastic member that supplies an elastic force to the contact protrusion to tightly contact the cam surface,
wherein the cam surface is formed to have a profile along which the unit display panel having the contact protrusion moves towards the adjacent unit display panel when the two housings are completely unfolded.

3. The foldable multi-display apparatus of claim 2, wherein the contact protrusion comprises a damper on a lower end thereof to reduce an impact between the contact protrusion and the one of the pair of housings when the two housings are completely unfolded.

4. The foldable multi-display apparatus of claim 3, wherein a gap between the damper and one of the pair of housings is approximately 0.3 mm in a folded state.

5. The foldable multi-display apparatus of claim 3, wherein the damper is formed of a rubber material.

6. The foldable multi-display apparatus of claim 2, wherein the cam surface is a groove formed to have the profile on an external circumference of a cylinder of the cam member, wherein the groove has a maximum depth corresponding to the traveling distance of the contact protrusion is 0.5 mm.

7. The foldable multi-display apparatus of claim 1, wherein the two display panels are located inside the two housings not to be exposed to the outside when the two housings are folded.

8. The foldable multi-display apparatus of claim 1, wherein the unit display panels are located outside of the two housings to be exposed to the outside when the two housings are folded.

9. The foldable multi-display apparatus of claim 1, wherein the device mounted in the unit display panel is one liquid crystal displays (LCDs), field emission displays (FEDs), plasma display panels (PDPs), and organic light-emitting diodes (OLEDs).
